(19) United States
(12) Patent Application Publication
(10) Pub. No.: US 2025/0162507 A1
(43) Pub. Date: May 22, 2025

(54) LOW PROFILE SLIDING TRUCK BED TRAY WITH INTEGRAL AND SECURE STORAGE

(71) Applicants: Scott M. Packer, Highland, UT (US); Jessie Villa, West Bountiful, UT (US)

(72) Inventors: Scott M. Packer, Highland, UT (US); Jessie Villa, West Bountiful, UT (US)

(21) Appl. No.: 18/935,374

(22) Filed: Nov. 1, 2024

Related U.S. Application Data
(60) Provisional application No. 63/595,273, filed on Nov. 1, 2023.

(51) Int. Cl. B60R 5/04

(52) U.S. Cl. CPC B60R 5/041

(57) ABSTRACT

The present invention is a system and method for providing a low profile sliding tray that only uses two screws to mount two low profile rear sliding assemblies, the sliding tray including rear rollers that slide on existing raised corrugated structures in the truck bed, and two guide rollers that rest in and abut against walls of channels between the raised corrugated structures, wherein the rear sliding assemblies include rollers disposed in the C-channels on either side of the sliding tray, and wherein the sliding tray is only raised the height of the rear rollers above the bed.

### BACKGROUND

### Field of the Invention

This invention relates generally to a low-profile sliding tray that is disposed in the bed of a pickup truck, wherein the tray is easily accessible and may also include an integral and secure storage box.

### Description of Related Art

Pickup trucks are sold more than any other vehicle in the United States providing utility with attractive designs. Because of the truck's versatility, it has found many uses as not only a work horse for the tradesman but used for everyday transportation.

The most useful feature of a pickup truck is its bed. The OEM typically sells the truck with very few additional features or accessories because there are countless aftermarket options to configure a truck for an individual's needs. Some of the more common accessories include Tonneau Covers, racks, etc.

Because of increasing crime across the country, there has been an increasing demand for Tonneau or truck bed covers that secure personal items, especially expensive tools in the truck bed. This has also driven the sale of truck bed covers that are heavier, more secure and can carry weight on top of the bed cover. These types of covers create a flatbed truck storage room in the truck bed. Overlanding, a rapidly emerging market, uses these covers to mount tents and other gear for off road camping while providing storage room below the cover.

More effective storage and space utilization is attempted with the installation of a pullout drawer system or flat trays mounted to the truck bed that pull out past the tail gate to allow access to tools and gear. These products are driven by the need to utilize every bit of space in a pickup truck.

A well-equipped truck now costs upwards of $100,000 so the amount of usable space not only in the truck cab but especially in the truck bed is crucial. The most significant problem with the current design of both the drawers and flat trays is the reduction of usable space inside the truck bed. This is because the drawers and trays rely on a roller slide or frame. These must be attached to a support structure which in turn is attached to the truck bed. The other side of the roller is attached to a drawer or tray.

The result of this design and construction is a loss of significant space as the drawers or trays must be raised above the bed to accommodate the entire roller system. This is a major shortcoming if the truck bed has a cover on top since the space between the top of the tray or drawer system is greatly diminished and virtually unusable for typical items that are typically transported. In a short bed truck (6 ½ foot bed) there is a loss of 1 cubic foot for every half inch of space above the bottom of the truck bed that is used for mounting a tray. The typical space used by the tray system is 4 to 7 inches above the bed. Drawer systems are as much as 14 inches above the bed.

Another problem these tray and drawer systems pose is significant added weight that reduces the trucks' payload. In most cases the higher load capacity of the trays or drawer systems requires more product weight to support the higher loads thus reducing the useable payload. There is also a loss of usable space on the sides of these systems. Another perspective on these systems is that they occupy the prime space of a truck bed while making the remaining space unusable when a truck bed cover is utilized.

Accordingly, it would be an advantage over the prior art to provide a low-profile truck bed tray that does not add significant weight to a vehicle, which begins at no more than a quarter inch off the bed of the pickup truck and does not add structural elements to the bed.

### BRIEF SUMMARY

The present invention is a system and method for providing a low profile sliding tray that only uses two screws to securely mount two low profile rear sliding assemblies, the sliding tray including rear rollers that slide on existing raised corrugated structures in the truck bed, and two guide rollers that rest in and abut against walls of channels between the raised corrugated structures, wherein the rear sliding assemblies include rollers disposed in the C-channels on either side of the sliding tray, and wherein the bottom of the sliding tray is only raised to the height of the rear rollers above the bed.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of a truck bed, a tailgate, and a single low profile truck bed tray.

FIG. 2 is a perspective view showing a close-up view of the back of the low-profile sliding tray.

FIG. 3 is a close-up perspective view of the low-profile sliding tray at the end of the truck bed where the tray meets a sliding mechanism.

FIG. 4 is a perspective view showing the low-profile sliding tray that is moved until it is positioned near the end of the tailgate.

FIG. 5 is a perspective and close-up view of the rear roller assembly.

FIG. 6 is a perspective view of the low-profile sliding tray that is being modified to operate within a vault.

FIG. 7 is a perspective and close-up view of the front panel of the vault that is being attached to the front end of the low-profile sliding tray.

FIG. 8 is a perspective view of the top portion of the vault that is secured to the truck bed using tamper resistant bolts, with the low-profile sliding tray disposed underneath or inside the vault.

FIG. 9 is a perspective view of the vault showing the low-profile sliding tray inside it, and a second low-profile sliding tray disposed on top of the vault so that the vault still enables a low-profile sliding tray to be used outside the vault.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

A novel design is disclosed to increase usable space in a truck bed significantly while using a unique roller system for trays. The truck bed is most likely to be found in a pickup truck. However, it is noted that any trailer or similar type of vehicle or surface may be modified to include the low-profile sliding tray of the present invention.

The first embodiment of the present invention is directed to a low-profile sliding tray 10 that uses the existing structure of a truck bed 12 to provide structure for both supporting and guiding the low-profile sliding tray. By using the existing structure in the truck bed 12, the low-profile sliding tray 10 is kept simple and straightforward in its design. Thus, the fundamental difference between other sliding trays and this first embodiment is to not use the tray support structure common to all other designs but instead to use the truck bed itself as the roller track and the corrugated bottom as the guide structure.

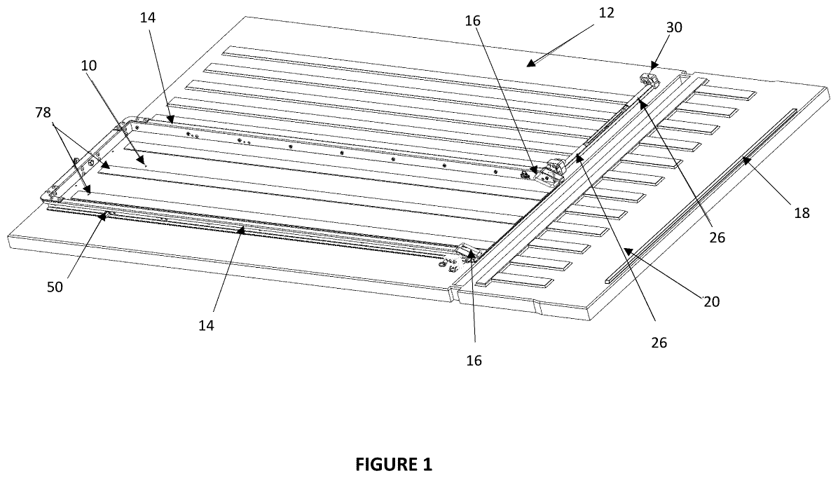

The first embodiment of the invention includes the relatively low-profile sliding tray 10 as shown in FIG. 1. The low-profile sliding tray 10 may be an aluminum structure to decrease the weight of the system. The low-profile sliding tray 10 is shown as a rectangular structure having two C-channels 14 on either side of the low-profile sliding tray 10. The C-channels 14 may be constructed of steel to provide the load bearing strength that is needed. The low-profile sliding tray 10 has been shown to manage over two thousand pounds of weight without structural deformation.

The first embodiment is shown having two low-profile sliding trays 10 in the truck bed 12. This number of trays is optimal for most loads and uses.

However, in an alternative embodiment, a single sliding tray may be provided as long as there is at least one supporting structure underneath a middle portion of the low-profile sliding tray 10 to provide support and prevent deformation.

The supporting structure may be a non-moving structure such as a raised nylon support upon which the low-profile sliding tray 10 may slide, or it may be a moving structure that includes one or more rollers.

The low-profile sliding tray 10 of the first embodiment includes low profile handles 16 that are not disposed in a vertical position but are instead shown in a slanted position. The purpose of this position of the low-profile handles 16 is to prevent the handles from interfering with loading and unloading of material on and off the low-profile sliding tray 10. Vertical handles would most likely catch on and interfere with movement of materials.

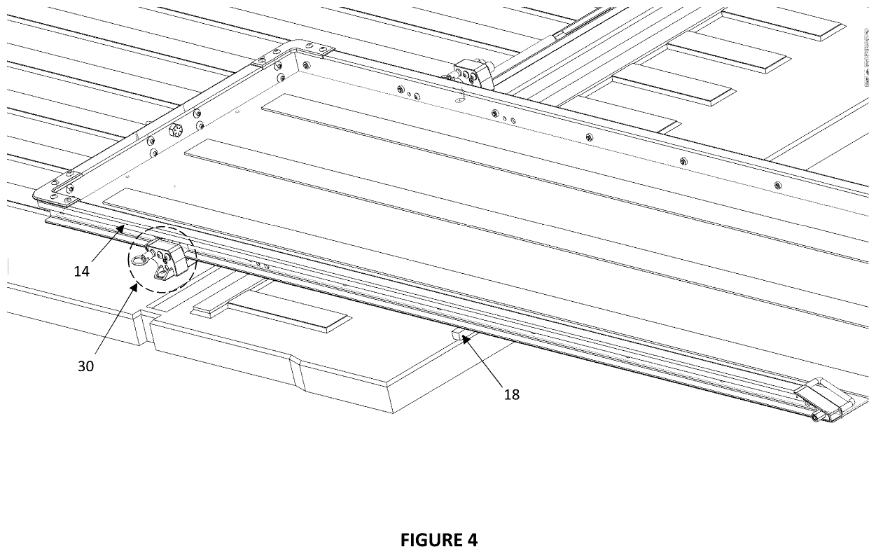

The low-profile sliding tray 10 may also include a tailgate support 18 as shown in FIGS. 1 and 4. The tailgate support 18 may be a non-moving support structure such as a nylon riser. It is noted that the tailgate 20 is typically parallel to the truck bed 12 but raised in a plane slightly above it. Therefore, the height of the tailgate support 18 will need to be customized to the height of the low-profile sliding tray 10.

It is noted that the low-profile sliding tray 10 may slide completely off a rear roller assembly when needed. There is no catch or other structure that would stop this movement in the first embodiment. However, in an alternative embodiment, the low-profile sliding tray 10 may include a stopping structure to prevent accidental slide-off.

FIG. 1 shows that the low-profile sliding tray 10 may include a grip surface 78 added to the inside of the tray. The grip surface 78 may be included as individual strips or covering the entire inside surface.

FIG. 1 also shows that at the rear of the truck bed 12 near the tail gate 20 is the only structural element that is added to the bed. FIG. 1 shows a rear roller assembly 30 that is not covered by a sliding tray for easier viewing, and another rear roller assembly that is covered.

Finally, FIG. 1 shows stops or holes 50 that can be used to stop the low-profile sliding tray 10 from sliding out of the truck bed 12. The manner of use will be explained later in this document.

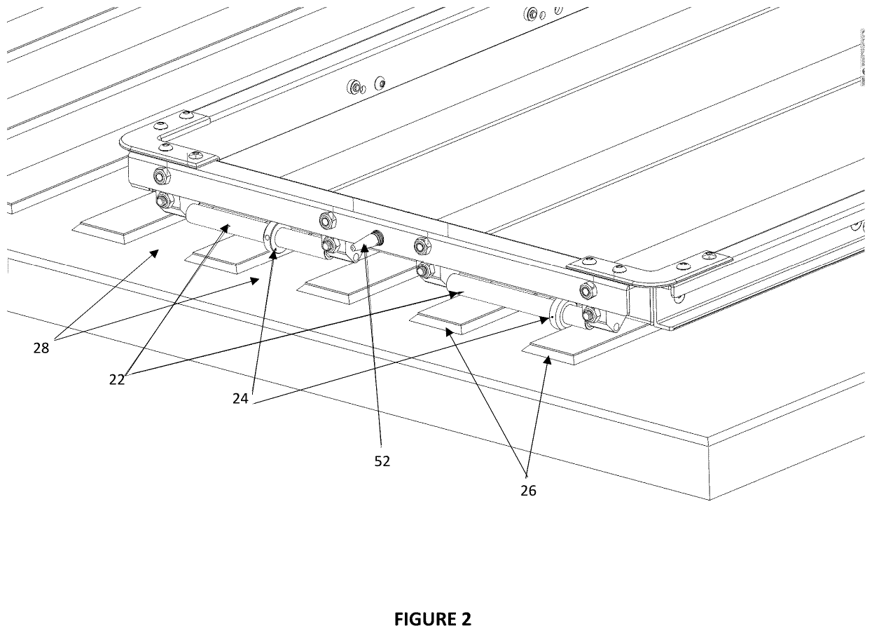

FIG. 2 shows that the first embodiment utilizes a set of long rear rollers 22 attached to the rear of the low-profile sliding tray 10. Importantly, these long rear rollers 22 roll on the truck bed 12 itself. Attached to the long rear rollers 22 are a fixed set of guide rollers 24. The guide rollers 24 are rings that are disposed around the circumference of the long rear rollers 22. The guide rollers 24 keep the low-profile sliding tray 10 aligned with the truck bed 12 while sliding in and out by butting up against an existing ribbed bed structure 26. It should be noted that multiple guide rollers 24 may be used around each of the long rear rollers 22, and they are not limited to the single guide roller shown. The use of multiple guide rollers 24 on each long rear roller 24 may increase stability of the low-profile sliding tray 10.

As shown in FIG. 2, the bottom surface of the truck bed 12 typically includes a plurality of raised or ribbed segments 26 and a plurality of channel segments 28. The guide rollers 24 extend into the channel segments 28 and are butted up against the sides of the ribbed segments 26. By using the raised rib segments 26 as the structure that the long rear rollers 22 roll upon, and the channel segments 28 as a guide for the guide rollers 24, no additional structural elements are added to the truck bed 12 to perform the rolling and guiding functions.

It is also noted that the structure of ribbed segments 26 may vary for different truck beds 12. For example, the width of the ribbed segments 26 may we wider or narrower. Accordingly, it is possible to move the position of the guide rollers 24 on the long rear rollers 22. It may also be possible to alter the shape of the guide rollers 24 to conform better to the sides of the ribbed segments 26. For example, the sides of the ribbed segments 26 may be substantially slanted. Therefore, the guide rollers 24 could also be slanted to better conform and make increased contact with the ribbed segments 26.

FIG. 2 also shows a bayonet 52 that extends from the back of the low-profile sliding tray 10. The bayonet 52 may be used as a bumper to cushion the movement of the low-profile sliding tray 10 as it moves backwards into the truck bed 12. Accordingly, the bayonet may be comprised of a rubber, rubber-like, or felt-like material, but any material that will cushion the movement of the low-profile sliding tray 10 as it slides into the truck bed 12 may be used.

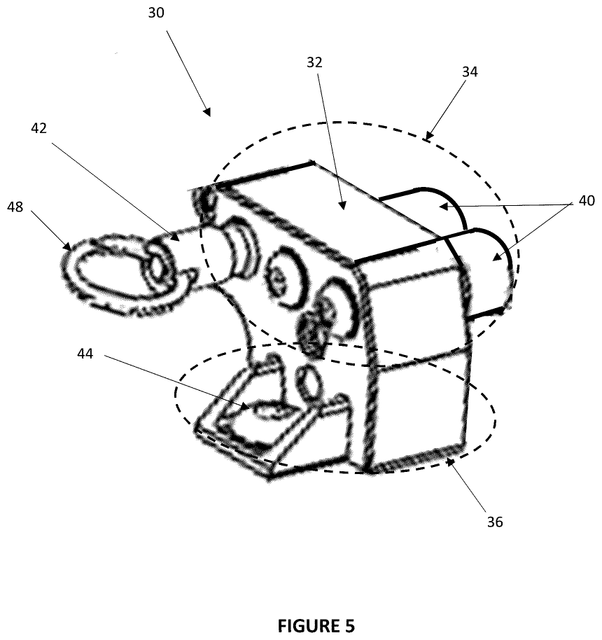

As shown in FIG. 5, the rear roller assembly 30 may be comprised of a riser 32, a head 34 on the riser, a base 36 on the riser, one or more head rollers 40, and a spring plunger lock 42.

The rear roller assembly 30 is the only structure that needs to be anchored to the truck bed 12. This may be accomplished at the base 36 of the riser 32. The base 36 of the riser 32 includes a single screw 44 that may function much like a drywall anchor that expands at an end thereof to anchor the rear roller assembly 30 to the truck bed 12.

Each low-profile sliding tray 10 needs a rear roller assembly 30 on each side of the tray. One screw 44 is used in each of the rear roller assemblies 30. The rear roller assemblies 30 also have a rear assembly roller 46 as shown in FIG. 1 that extends between them and upon which the low-profile sliding tray 10 rests.

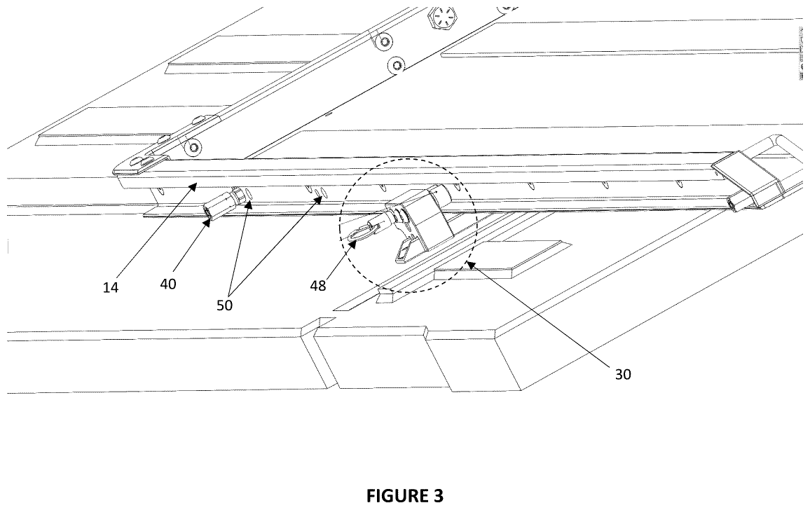

The head 34 on the rear roller assembly 30 may include head rollers 40 that fit within the C-channel 14 on the low-profile sliding tray 10 as shown in FIGS. 1, 3 and 4. The number of head rollers 40 may be increased or decreased but is found to function well with two head rollers. FIG. 3 shows the structure of the head rollers 40 outside of the head 34.

The spring plunger lock 42 on the rear roller assembly 30 may be used to lock the low-profile sliding tray 10 in place by engaging one of the plurality of holes 50 along the C-channel 14 as shown in FIG. 3. The spring plunger lock 42 may include a ring 48 that is pulled to disengage the spring plunger lock 42 from a hole in the C-channel 14, and then released to engage the same or different hole in the C-channel.

FIG. 4 is provided as a perspective view showing the low-profile sliding tray 10 extended outwards from the truck bed 12. This figure shows how the low-profile sliding trays 10 resting on the tailgate support 18 while the rear roller assembly 30 is used to lock the tray so that it cannot slide out further.

It is noted that the head rollers 40 may be a set of larger rollers that guide the low-profile sliding tray 10 within the channel segments 28. Since the low-profile sliding tray 10 is low profile and light weight, stiffening elements are used on the side of the tray to minimize tray deflection as it is supported on each end by rollers with no support in between.

The low-profile sliding trays 10 themselves become a modular platform to increase the utility of a truck bed 12. For example, the low-profile sliding tray 10 may be the lower portion of a vault 60. This is important because if guns are locked in the cab of a truck they can be seen, and the glass can be easily broken to steal the weapons. To store the guns in the truck bed 12 there must be a secure tonneau cover on top of the bed and the guns must be stored in their hard cases. This takes up a significant amount of room in the bed and eliminates usable space. The need to optimize space may be better provided by having a lockable vault that is waterproof and dustproof and that eliminates the need for hard cases.

In addition, the vault 60 may be easily removable along with the low-profile sliding tray 10 and allows the owner to utilize the truck bed 12 for other activities. It is noted that the main advantages of such a vault system includes the fact that there are no other vault systems that can be removed from a truck bed 12 or are light weight to preserve the payload needed for other activities.

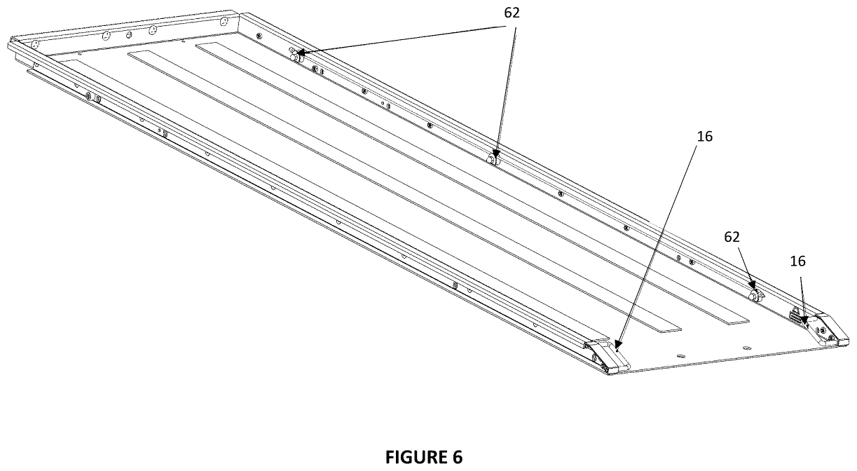

FIG. 6 shows the low-profile sliding tray 10 of the first embodiment of the invention. The low-profile sliding tray 10 may be modified in a second embodiment of the invention by removing the low-profile handles 16. This may be accomplished by removing attachment bolts. The low-profile sliding tray 10 is also shown having an internal tie down system 62 on both sides of the tray.

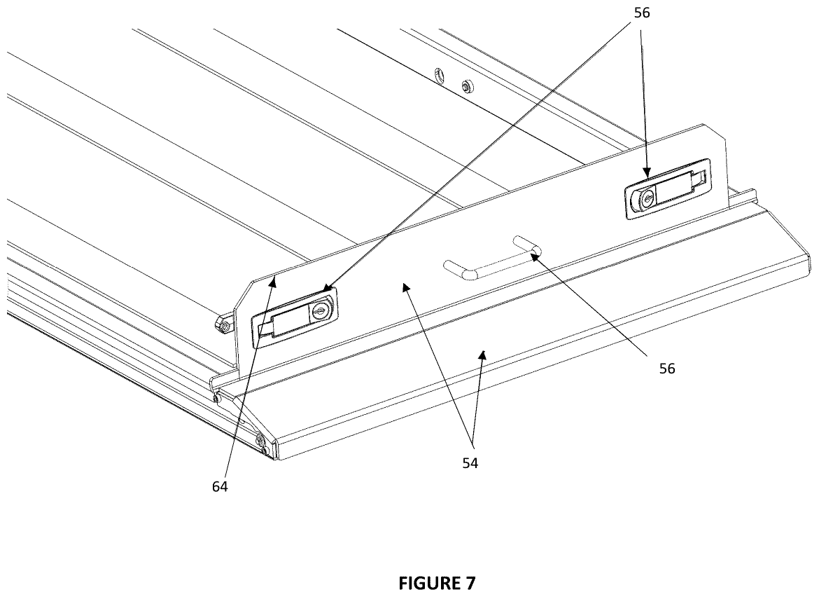

The next step is to mount a face panel 54 as shown in FIG. 7. The face panel 54 may include a handle 56 so that the low-profile sliding tray 10 can still be moved in and out of the truck bed 12. The face panel 54 may also include one or more locks 56. The locks 56 may be waterproof because they may be exposed to the weather. The shape 64 of the front panel 54 is made to be able to seal access to the vault 60.

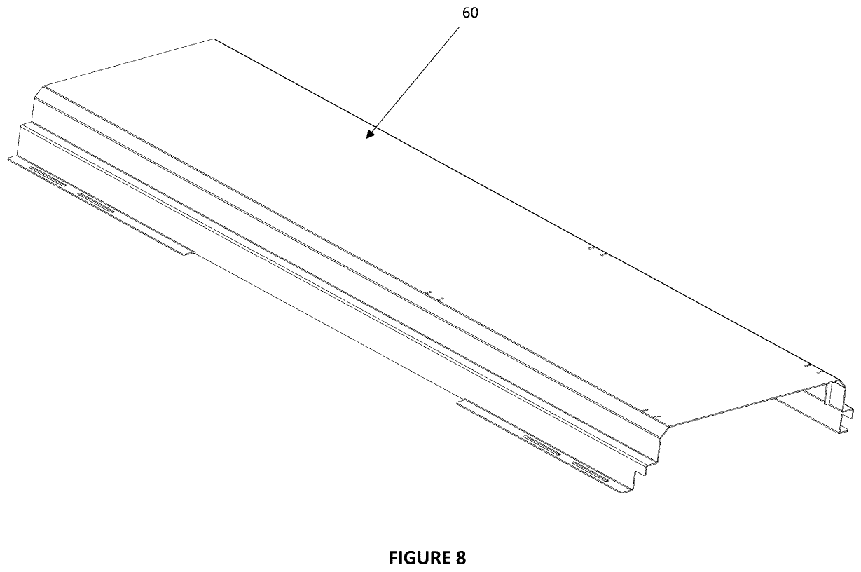

The vault 60 is then mounted to the truck bed with tamper resistant Torx Bolts, or any other system or tamper resistant bolts 74 that prevents tampering with the vault. The vault is placed directly over an installed low-profile sliding tray 10. The vault 60 may be shaped as shown in FIG. 8. The vault 60 is secured to the truck bed 12. The low-profile sliding tray 10 will not be removable from the truck bed 12 as long as the vault 60 remains secured to the truck bed and the locks 56 are secure. The vault 60 may have a cover on the end opposite the face plate 54, or it may be placed firmly against the inside of the pickup bed 12 to seal the end.

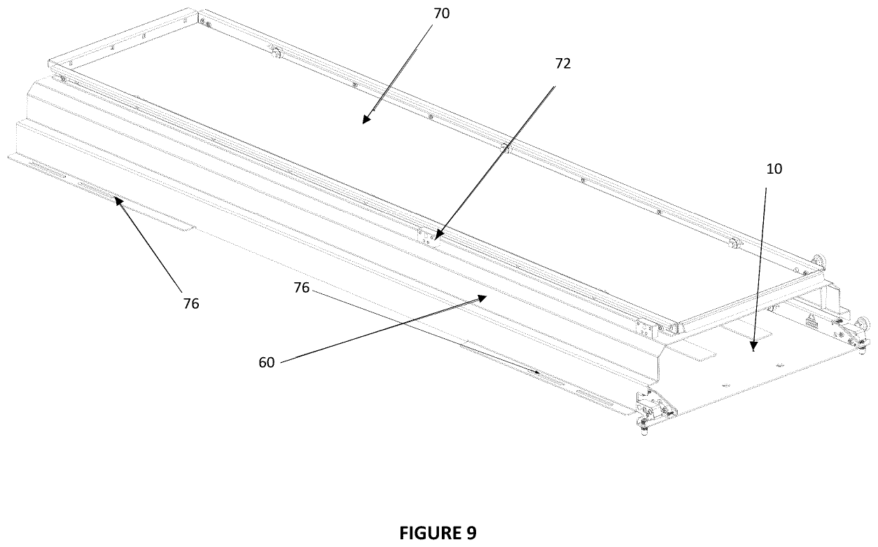

FIG. 9 shows the assembled vault 60 with an internal low-profile slide tray 10 inside of it. In a third embodiment of the invention, another low-profile slide tray 70 may also be mounted on a top surface of the vault 60. In this way, the truck bed 12 has a vault 60 and does not miss the advantage of also having the low-profile slide tray 10 outside the vault for use.

The external low-profile slide tray 70 does not have the same system for rolling as the low-profile slide tray 10 because it is mounted on the top of the vault 60. Instead, the external low-profile slide tray 70 may use roller blocks 72 positioned along the top of the vault 60. By using at least four roller blocks 72, the external low-profile slide tray 70 is kept in place so as to keep it in parallel with a long axis of the vault 60.

FIG. 9 also shows the numerous slots in the vault 60 for the tamper resistant bolts 72 to be disposed for securing the vault to the truck bed 12.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A low-profile sliding tray for use in the bed of a truck, said system comprised of:
a bed of a truck;
a low-profile sliding tray having a first end and a second end, wherein the tray is substantially planar;
a first rear roller assembly disposed near the first end of the low-profile sliding tray, wherein the first rear roller assembly is attached to the bed of the truck;
a second rear roller assembly disposed near the first end of the low-profile sliding tray, wherein the second rear roller assembly is attached to the bed of the truck;
wherein the first and second rear roller assemblies are disposed across from each other with the low-profile sliding tray disposed thereon such that the first and second rear roller assemblies are supporting the first end of the low-profile sliding tray;
at least one long roller attached to the second end of the low-profile sliding tray and resting on the truck bed such that the at least one long roller is holding the second end above the truck bed, wherein the at least one long roller is able to roll along the truck bed;
at least one guide roller disposed around the at least one long roller; and
wherein the low-profile sliding tray is free to move substantially parallel to a surface of the truck bed and perpendicular to a line between the first and second rear roller assemblies.
